(19) United States
(12) Patent Application Publication
(10) Pub. No.: US 2003/0131443 A1
(43) Pub. Date: Jul. 17, 2003

(54) Release rod grommet

(76) Inventor: Robert S. Trent, Berwyn, IL (US)

Correspondence Address: Lee, Mann, Smith, McWilliams,, Sweeney & Ohlson, P.O. Box 2786, Chicago, IL, 60690-2786, US

(21) Appl. No.: 10/308,437

(22) Filed: Dec. 3, 2002

Related U.S. Application Data
(60) Provisional application No. 60/337,257, filed on Dec. 3, 2001.

(51) Int. Cl. H02G 3/22; F16B 37/04

(52) U.S. Cl. 16/2.1; 411/182

(57) ABSTRACT

A grommet adapted to accommodate more than one depth of hole or thickness of mating material. The grommet includes a base member having a central aperture. The grommet has at least two retaining tabs adapted for different depth holes or thicknesses of mating material. The tabs extend perpendicular to the base member and are adapted to be seated and retained within the hole to be protected.

This application claims the benefit of U.S. Provisional Patent Application Serial No. 60/337,257 filed Dec. 3, 2001.

### BACKGROUND OF THE INVENTION

The present invention relates to a wear grommet adapted to accommodate more than one depth of hole or thickness of mating material. The grommet is preferably adapted to seat in and protect a release rod hole provided in a bracket along the underside of a railcar or through the side sill through which a railcar brake release rod passes.

In the typical railcar assembly, a brake release rod passes through a release rod hole provided in a bracket positioned along the underside of the railcar or through the side sill. The release rod holes come in a variety of geometries, including round and oval or slotted, and with a variety of depths or thicknesses in the material incorporating the hole. When the railcar is in service, the brake rod vibrates in the hole and hammers the edge of the bracket or side sill thus causing damage to the rod and surface of the hole, which leads to unwanted maintenance or possibly failure.

It is generally known and a common practice in the railway industry to provide wear members to protect elements susceptible to excessive wear damage. This is usually accomplished by wear members adapted to be attached to the element or in the wear area and that are made of suitable materials to resist the wear or absorb the wear forces and be easily replaced at a lesser cost than replacing the protected element. The release rod holes are generally protected by inserting a wear grommet. The wear grommet includes a base member having a central bore. The central bore is defined by a number of outwardly extending tabs perpendicular to the planar member including the release rod hole. The outwardly extending tabs include a retaining lip such that when the tabs are inserted and forced through the hole, the retaining lip engages a rearward surface of the planar member and retains the grommet in the hole.

One of the problems with such previous grommet structures is that the grommets are limited to use with a single hole depth or thickness of the material the hole is formed in. Previous grommets for the release rod holes are designed to fit a single shaped hole and adapted to accommodate a single depth of the hole or thickness of penetration of the tabs. This requires the railways to keep multiple sizes of grommets on hand for replacement of the worn grommets of various shapes and for the various release rod hole depths or thicknesses of material in which the holes are formed. This multiple size requirement adds additional inventory costs for the railways, as well as, additional costs to the manufacturers to manufacture the variety of sizes.

The wear grommet of the present invention is adapted to accommodate, preferably for a release rod hole, more than one hole depth or thickness of material, thus reducing the number of different sized grommets required to be kept on hand. The present grommet can be installed similarly to traditional grommets, without need for the use of special hardware or tools. The grommet is structurally and operationally simple, durable, easy to install, and requires minimal manipulation to position and secure the grommet in a hole.

An object of this invention is to reduce the number of different sized grommets required for railway applications. It has therefore been found beneficial to produce a one-piece grommet that can accommodate more than one depth of hole or thickness of material. Moreover, it would be significant in the railway industry to provide a grommet that can accommodate more than one depth of hole or thickness of material, which is not found with the prior art grommets that have a single-depth retaining tab.

These and other objects and advantages of the invention will be apparent from the following description, the accompanying drawings and the appended claims.

### SUMMARY OF THE INVENTION

A grommet of the present invention overcomes the foregoing disadvantages and provides a readily manufactured, easily used, and reliable grommet adapted to accommodate more than one depth of hole or thickness of mating material. The present invention provides a grommet that can be easily and conveniently manufactured from a suitable moldable material.

The grommet may be described as a one-piece grommet that is easily manipulated by inserting, and snapping into a hole without any other component or step. The grommet includes a base member having a central aperture. The total width of the base member from a first outer edge to an opposing outer edge is selected to be greater than the diameter of the hole in which the grommet is adapted to be seated. The base member includes at least two retaining tabs, each adapted for a different hole depth or thicknesses of mating material and extending perpendicular to the base member. The at least two retaining tabs are adapted to seat within holes to be protected.

Preferably, the base member includes at least two identical and complimentary tab sets positioned at opposite sides of the central aperture and extending perpendicular to the base member, each tab set including at least two retaining tabs that are adapted to seat in holes of differing depths and securably retain the grommet.

It is contemplated that the grommet can be manufactured to accommodate any size and any geometrical shape envisioned for a respectively shaped hole to be protected.

The present invention overcomes the need for multiple sizes of grommets to accommodate different hole depths or thickness of mating surface material by including at least two retaining tabs, each adapted for securing the grommet in different depths of holes or with materials of different thickness.

### BRIEF DESCRIPTION OF THE DRAWINGS

The above mentioned and other features of this invention and the manner of obtaining them will become more apparent and the invention itself will be best understood by reference to the following description of embodiments of the invention taken in conjunction with the accompanying drawings in which:

FIG. 1 is a top plan view of a grommet according to the invention;

FIG. 2 is a partial cutaway section view taken along section line 2-2 of FIG. 1;

FIG. 3 is an enlarged, partial view of the cross section view of FIG. 2 denoted by dashed line 3;

FIG. 4 is a cross section view taken along section line 4-4 of FIG. 1;

FIG. 5 is a partial cross section taken along section line 5-5 of FIG. 1;

FIG. 6 is an enlarged, partial cutaway view of the tab area of FIG. 4 denoted by dashed line 6;

FIG. 7 is a cross section view of an alternative embodiment of the grommet of FIG. 1;

FIG. 8 is a top plan view of an alternative embodiment of the present invention including three different tab heights;

FIG. 9 is a cross section view taken along line 9-9 of FIG. 8;

FIG. 10 is an enlarged partial view of hte area of FIG. 9 encircled by line 8;

FIG. 11 is a cross section view taken along section line 11-11 of FIG. 8;

FIG. 12 is a cross section view taken along section line 13-13 of FIG. 8; and,

FIG. 13 is a cross section view taken along section line 15-15 of FIG. 8.

### DETAILED DESCRIPTION OF THE INVENTION

While the present invention will be described fully hereinafter with reference to the accompanying drawings, in which different embodiments are shown, it is to be understood at the outset that persons skilled in the art may modify the invention herein described while still achieving the desired result of this invention. Accordingly, the description that follows is to be understood as a broad informative disclosure directed to persons skilled in the appropriate art and not as limitations of the present invention.

In the figures, like reference numerals indicate the same elements throughout. A preferred grommet 10 is best seen in FIG. 1, which shows a top plan view of the grommet 10 according to the present invention. The grommet 10 is formed from a suitably wear resistant material, such as molded nylon or other suitable plastic, and includes a base member 20. As shown in FIG. 2, the base member 20 includes a front surface 21 and a rear surface 22. The base member 20 further includes a central aperture 24 adapted to geometrically compliment a hole in which it is designed to seat. Although the grommet 10 is shown in the shape of an oval, preferably to fit a slotted hole, any shape, such as circular and square, may be envisioned and are within the scope of the invention.

The base member 20 preferably includes a first lip 26 and a second lip 28 positioned adjacent to the central aperture 24 and on opposing sides thereof. The first and second lips 26 and 28 extend perpendicular to the planar axis of the base member 20 and from the rear surface 22 of the base member 20. The first and second lips 26 and 28 are adapted to extend into and follow the curvature of the slot or hole that is to be protected when the grommet 10 is seated in the hole, while a peripherally extending portion 23 of the base member 20 rests on an outer surface of the material in which the hole is formed (not shown). The first and second lips 26 and 28 define a grommet width 12 and length 12a equal to the inner width and length of the hole or slot to be protected.

The base member 20 further includes a first tab set 30 and a second tab set 32 positioned adjacent to the central aperture 24 and on opposing sides thereof. Tab sets 30 and 32 are formed in association with the first and second lips 26 and 28. Each tab set 30 and 32 extends perpendicular to the planar axis from the rear surface 22 of the base member 20. As best illustrated in FIGS. 2 and 3, preferably each tab set 30 and 32 includes a first tab 40, a second tab 41 and a third tab 43. Tabs 41 and 43 are preferably identical and positioned on opposing sides of tab 40. The tabs 40, 41 and 43 include an inner surface 44 and an outer surface 46 defining a reduced tab width 45.

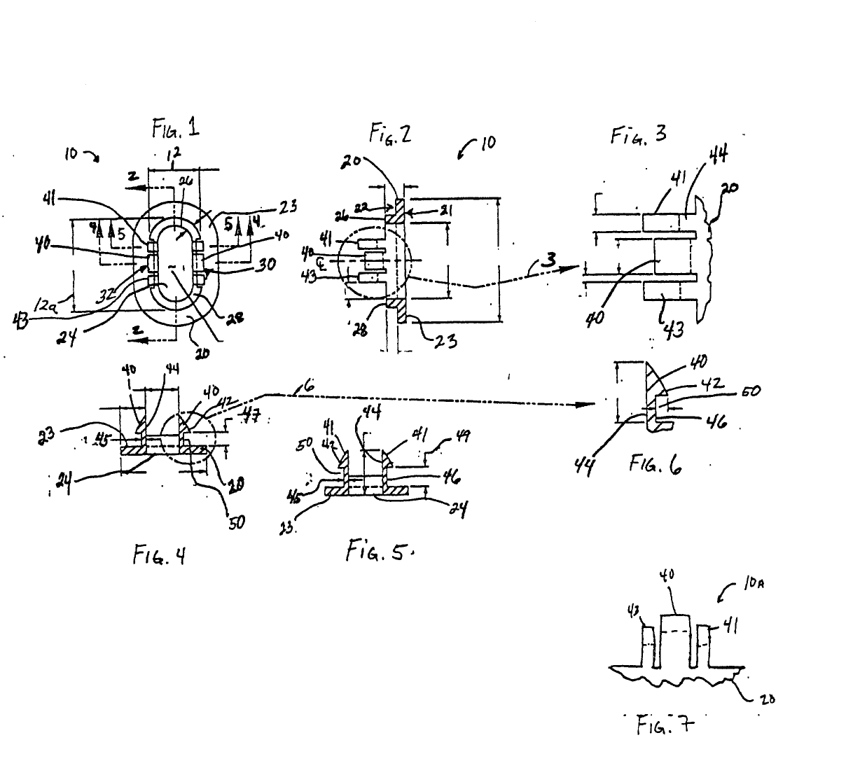

More clearly shown in FIGS. 4-6, each outer surface 46 includes a retaining barb 42 (which may be larger than shown for greater contact) extending outwardly and parallel to the base member 20. Together, the base member 20, reduced tab width 45 and retaining barb 42 define a locking channel 50. As shown in FIGS. 2 and 3, the tab 40 and identical tabs 41 and 43 may vary in height and include locking channels of different heights. This is more clearly shown in FIGS. 4 and 5, which are cross sectional views through tabs 40 and 41 respectively. In FIG. 4, barb 42, reduced width 45 and base member 20 form locking channel 50 having a height 47. In FIG. 5, barb 42, reduced width 45 and base member 20 form locking channel 50 having a height 49. Height 47 is greater than height 49, thus the grommet 10 may accommodate holes formed in materials having a thickness equal to about 47 or about 49, or for example, formed in ⅜ inch or ¼ inch steel.

A person of ordinary skill in the art will appreciate that the number and the dimensions of tabs may be varied to adapt for varying sizes of holes and varying degree of retaining strength, so long as the grommet 10 includes two tabs having different locking channel heights. Preferably, and as shown in FIGS. 1-6, the grommet 10 includes two opposing tab sets having three tabs. FIG. 7 depicts an alternative embodiment of the present invention, marked grommet 10a, wherein tabs 41 and 43 include a shorter locking channel than central tab 40.

The grommet 10 is inserted by simply forcing the grommet 10 into the hole to be protected. When inserting the grommet 10, the reduced width 45 of each tab 40, 41 and 43 allows for resilient deflection inwardly to the central aperture 24 and thus allows the tabs 40, 41 and 43 to pass through the hole to be protected. After insertion, the retaining barbs 42 extend outwardly beyond the inner diameter of the hole, thus overlapping and engaging an inner surface of the material in which the hole is formed. If the grommet 10 is inserted in a hole having a depth or thickness equal to the height 47, the barb 42 on tabs 40 will just extend through the hole and overlap with the inner surface of the material to securely retain the grommet 10. In such a scenario, tabs 41 and 43 will extend through the hole such that the barb 42 of each tab 41 and 43 extends beyond and does not engage the inner surface of the hole material. If the grommet 10 is inserted into a hole having a depth or thickness equal to height 49, the barb 42 of each tab 41 and 43 will pass through the hole and overlap with the inner surface of the material. However, the barb 42 of tab 40 will not pass through the hole, but will remain deflected within the hole.

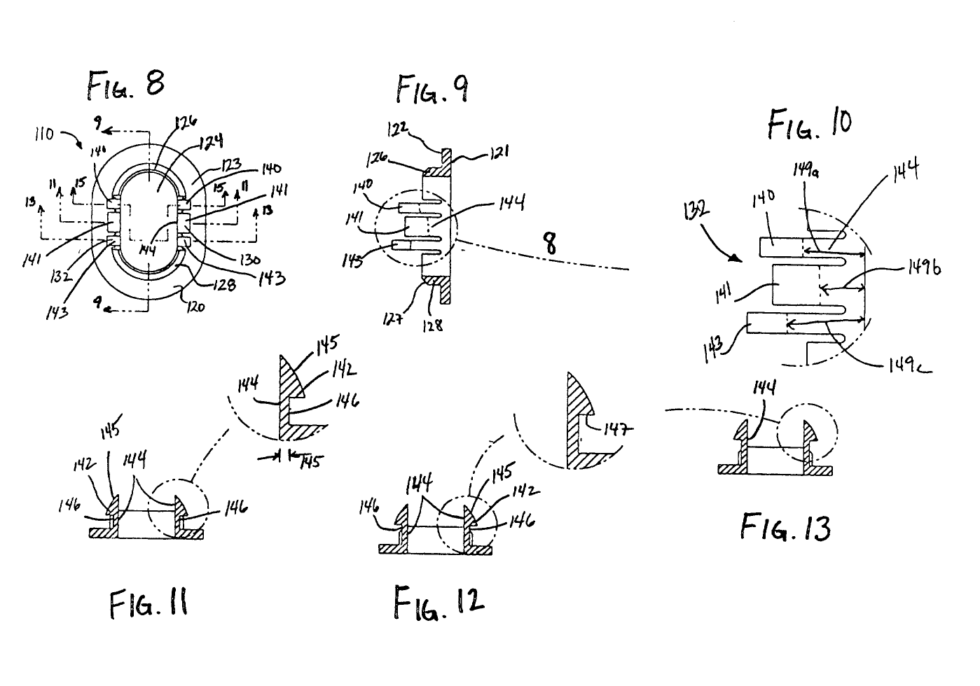

A most preferred embodiment of the present invention is illustrated in FIGS. 8-13 as grommet 110. Grommet 110 is formed from a suitable wear resistant material, such as described with reference to grommet 10 described in FIGS. 1-7. Grommet 110 includes a base member 120 having a front surface 121, rear face and a central aperture 124. The base member 120 includes a first lip 126 and a second 128 positioned adjacent the central aperture 124 on opposing sides thereof and extending perpendicular to the planar axis of the base member 120. The first and second lips 126 and 128 each include a beveled end 127 that provides for the easy insertion into the hole in which the grommet 110 is to protect. The first and second lips 126 and 128 are adapted to extend into and follow the curvature of the slot or hole that is to be protected when the grommet 110 is seated, while a peripherally extending portion 123 of the base member 120 rests on an outer surface of the material in which the hole or slot is formed, such as a metal bracket or side sill.

The grommet 110 further includes a first tab set 130 and a second tab set 132 positioned adjacent the central aperture 124 and extending perpendicularly from the rear surface 122 of the base member 120. The first and second tab sets 130 and 132 are positioned on opposing sides of the central aperture 124 between the first and second lips 126 and 128. As best illustrated in FIGS. 8 and 9, each tab set 130 and 132 includes a first tab 140, a second tab 141 and a third tab 143. As shown in FIGS. 11-13, the tabs 140, 141, and 143 include an inner surface 144 and an outer surface 146 defining a reduced tab width 145.

Best shown in FIGS. 11-13, the outer surface 146 of each tab 140, 141 and 143 includes a retaining barb 142 extending outwardly and parallel to the base member 120 and which is adapted to slip over and engage a rear surface of the material including the hole or slot to be protected. The retaining barb 142 includes a lower edge 147, which extends outwardly from the rear surface of the respective tab and parallel to the base member 120, and an upper edge 145 that slopes inwardly from the lower edge to the rear surface 144. In this manner, the tabs 140, 141 and 143 provide for easy insertion into holes or slots. The base member 120, reduced tab width 145 and retaining barb 142 define a locking channel 150. As seen in FIG. 10, the tabs 140, 141 and 143 are designed to provide three different locking channel heights 149a-c. The different locking channel heights 149a-c allows the grommet 110 to accommodate holes or slots formed in materials of three different thicknesses. Any number of tabs and locking channel heights may be incorporated. The operation and insertion of grommet 110 is essentially the same as that described in relation to grommet 10 before.

Although the preferred embodiments of the invention are illustrated and described in connection with particular features, they can be adapted for use with a variety of sizes and shapes of holes. Other embodiments and equivalent grommets are envisioned within the scope of the invention. Various features of the invention have been particularly shown and described in connection with the illustrated embodiments of the invention, however, it must be understood that these particular embodiments merely illustrate and that the invention is to be given its fullest interpretation within the terms of the appended claims.

What is claimed is:

1. A grommet adapted to be inserted and retained within a hole, said grommet including:
a base member having a front surface, a rear surface and a central aperture; said base member adapted to engage a first surface of a material;
a first tab extending outwardly from said rear surface, said first tab including a first inner surface and a first outer surface, said first tab includes a first retaining barb extending outwardly from said first outer surface, said first retaining barb and said base member defining a first locking channel height; and,
a second tab extending outwardly from said rear surface, said second tab including a second inner surface and a second outer surface, said second tab includes a second retaining barb extending outwardly from said second outer surface, said second retaining barb and said base member defining a second locking channel height, wherein,
said first locking channel height and said second locking channel height are different.

2. The grommet according to claim 1, wherein said base member includes first lip and a second lip, said lips extending from said rear surface of said base member on opposing sides of said central aperture and adapted to be seated within the hole.

3. The grommet according to claim 1, wherein said base member includes a peripherally extending portion adapted to rest against an outer surface of the mating material when said grommet is seated in a hole.

4. The grommet according to claim 1, including a third tab extending outwardly from said rear surface, said third tab including a third inner surface and a third outer surface, said third tab includes a third retaining barb extending outwardly from said third outer surface, said third retaining barb and said base member defining a third locking channel height; said third locking channel height being different than at least one of said first and second locking channel heights.

5. The grommet according to claim 1, wherein said grommet is a plastic.

6. The grommet according to claim 5, wherein said plastic comprises nylon.

7. A wear grommet adapted to be inserted into and retained in an opening, said grommet comprising:
a base member having a front surface, a rear surface and a central aperture;
a first tab set extending from said rear surface substantially parallel to the central axis of said central aperture, said first tab set including a first tab and a second tab, said first and second tabs including an inner surface facing said central aperture and an opposing outer surface facing away from said central aperture; said first and second tabs each including a retaining barb extending outwardly from said outer surface thereof; each of said first and second tabs including a locking channel defined by said rear surface of said base member, said outer surface of said tab and said retaining barb, the locking channel of said first tab having a different height than the locking channel of said second tab; and,
a second tab set extending from said rear surface substantially parallel to the central axis of said central aperture, said second tab set including a primary tab and a secondary tab, said primary and secondary tabs including an inner surface facing said central aperture and an opposing outer surface facing away from said central aperture; said primary and secondary tabs each including a retaining barb extending outwardly from said outer surface thereof; each of said primary and second tabs including a locking channel defined by said rear surface of said base member, said outer surface of said tab and said retaining barb, said locking channel of said primary tab having a different height than said locking channel of said secondary tab.

8. The grommet according to claim 7, wherein said first tab set and said second tab set are positioned on opposing sides of said central aperture.

9. The grommet according to claim 7, wherein said locking channel height of said first tab and said locking channel height of said primary tab are equal.

10. The grommet according to claim 9, wherein said locking channel height of said second tab and said locking channel height of said secondary tab are equal.

11. The grommet according to claim 7, wherein said base member includes a first lip and a second lip, said first and second lips extending from said rear surface of said base member on opposing sides of said central aperture and adapted to be seated within the opening.

12. The grommet according to claim 11, wherein said first and second lips include a beveled end.

13. The grommet according to claim 7, wherein said first tab set includes a third tab extending from the rear surface and having an inner surface, an opposing outer surface and a retaining barb extending outwardly from said outer surface, said third tab including a locking channel defined by said rear surface, said outer surface and said retaining barb; said locking channel of said third tab having a height different than said first tab and said second tab.

14. The grommet according to claim 7, wherein said second tab set includes a tertiary tab extending from the rear surface and having an inner surface, an opposing outer surface and a retaining barb extending outwardly from said outer surface, said tertiary tab including a locking channel defined by said rear surface, said outer surface and said retaining barb; said locking channel of said tertiary tab having a height different than said primary tab and said secondary tab.

15. A wear grommet adapted to be positioned within an opening in a material, said grommet including:
a base member having a rear surface, a front surface and a central aperture; and,
a plurality of tabs extending from said rear surface, each of said plurality of tabs including an inner surface facing said central aperture, an opposing outer surface facing away from said central aperture and a retaining member extending outwardly from said outer surface, said retaining member including a lower edge spaced from said rear surface and substantially parallel thereto, each of said plurality of tabs having a locking channel defined by said rear surface, said outer surface and said lower edge, each of said plurality of tabs having a locking channel height defined by the distance between said rear surface and said lower edge;
wherein at least two tabs of said plurality of tabs include locking channel heights that differ.

16. The grommet according to claim 15, wherein said plurality of tabs include at least three tabs having different locking channel heights

17. The grommet according to claim 15, wherein said plurality of tabs are provided in at least two tab sets, said tab sets positioned on opposing sides of said central aperture; each of said tab sets including at least two tabs having different locking channel heights.

18. The grommet according to claim 17, wherein each tab set includes an equal number of tabs and the tabs of each tab set are identical to the tabs included in an opposing tab set.

19. The grommet according to claim 15, wherein said plurality of tabs are provided in at least two tab sets, said tab sets positioned on opposing sides of said central aperture; each of said tab sets including at least three tabs having different locking channel heights.

20. The grommet according to claim 15 including a first lip and a second lip, said first and second lips extending from said rear surface of said base member on opposing sides of said central aperture, said first and second lips adapted to seat within the opening in the material.
